(19) United States
(12) Patent Application Publication
(10) Pub. No.: US 2011/0226723 A1
(43) Pub. Date: Sep. 22, 2011

(54) HOLLOW BODY WITH IMPROVED BARRIER ACTION

(75) Inventors: Christian Schade, Ludwigshafen (DE); Hans-Jürgen Renner, Neuhofen (DE); Stefan Burgdörfer, Mutterstadt (DE); Klaus Wendel, Grunstadt (DE)

(73) Assignee: BASF SE, Ludwigshafen (DE)

(21) Appl. No.: 13/048,352

(22) Filed: Mar. 15, 2011

Related U.S. Application Data
(60) Provisional application No. 61/314,612, filed on Mar. 17, 2010.

(51) Int. Cl. B65D 90/02; B32B 25/16; B32B 1/02; B29C 49/06

(52) U.S. Cl. 215/379; 428/36.6; 264/513

(57) ABSTRACT

The present invention relates to hollow bodies with improved barrier action, where the hollow bodies are composed of a three-layer sandwich structure with a shell made of polystyrene and with a middle layer as vapor barrier.

The present invention relates to hollow bodies with improved barrier action.

WO-A-2008/40821 describes the production of injection-stretch-blow moldings with a capacity of at least 250 ml. The PF also describes a method for giving the bottles an increased level of barrier action. For this, two-component injection molding is used in a known manner to produce a preform from the styrene polymer and from a suitable barrier material, and the preform is then blown to give a bottle.

The two polymers used are generally mutually incompatible, and they usually have different processing latitudes. Bottles composed only of two layers of these materials are therefore difficult to produce.

The present invention was therefore based on the object of overcoming the abovementioned disadvantages.

Accordingly, novel and improved hollow bodies with improved barrier action have been found, and are composed of a three-layer sandwich structure with a shell made of polystyrene and with a middle layer as vapor barrier; processes for producing these, and use, have also been found.

Polystyrene means rubber-free or rubber-containing polystyrene, or else means styrene-butadiene copolymers, or else means a mixture in which the polymers and/or block copolymers are present.

Rubber-free polystyrene is also termed GPPS (general purpose polystyrene).

Conventional rubber-containing styrene polymers comprise a rubber phase which is based on dienes and which has been dispersed in a hard matrix made of styrene polymer. Impact-resistant polystyrene (HIPS, high impact polystyrene) therefore comprises a hard polystyrene matrix and, dispersed therein, by way of example, polybutadiene rubber particles. It is obtained by first producing a rubber—e.g. in solution—and dissolving the rubber in styrene, and then polymerizing the mixture to give the HIPS.

The term polystyrene also includes styrene-butadiene block copolymers. The styrene-butadiene block copolymers can also be present in fully or partially hydrogenated form. The butadiene can also have been replaced entirely or to some extent by isoprene.

The hollow bodies of the invention with improved barrier action are composed of a three-layer sandwich structure with a shell made of polystyrene, with a middle layer as vapor barrier, and with an internal layer made of polystyrene.

The shell used can comprise any desired polystyrenes or mixtures of polystyrenes, preferably HIPS with weight-average molecular weight of from 150 000 to 240 000 D, with flowability of from 2 to 20 ml/10 min, measured at 200° C. using 5 kg to ISO 1133, and with rubber content of from 2 to 10%, or mixtures of HIPS with other polystyrenes, such as GPPS, with weight-average molecular weight of from 150 000 D to 450 000 D, or with styrene-butadiene block copolymers, particularly preferably HIPS with polybutadiene content of from 5 to 9% by weight and with average particle size of from 1.0 to 8.5 μm (median), determined via forward scattering of laser light.

Polymers suitable for a vapor-barrier middle layer are those which exhibit a higher gas barrier than polystyrene. Examples of suitable polymers are polyamides, polyesters, in particular PET, PVC, polyvinylidene fluoride, acrylonitrile copolymers having acrylonitrile content above 50%, polyvinylidene chloride, and polyvinylidene chloride copolymers, polyvinyl alcohol, or polyolefins.

Polyolefins suitable as vapor-barrier middle layer are those such as polyethylene polymers, e.g. HDPE (high-density polyethylene), LDPE (low-density polyethylene), or LLDPE (linear low-density polyethylene), ethylene/propylene copolymers, ethylene copolymers, e.g. ethylene/α-olefin copolymers, ethylene/vinyl acetate copolymerse, ethylene/vinyl alcohol copolymers, ethylene/alkyl acrylate copolymers, ethylene/acrylic acid copolymers, or ethylene/styrene copolymers, chlorinated polyethylene, polypropylenes, such as PP (polypropylene) homopolymers, random and block PP copolymers, α-olefin copolymers, and PP blends. Other polyolefins are also suitable, examples being poly-4-methylpent-1-ene, polyisobutene, cycloolefin copolymers, and EPDM (ethylene-propene-diene copolymers). These polymers can be used individually or in a mixture with one another. The polymers can also comprise other blend components, in particular those which improve adhesion or compatibility with respect to the polystyrene shell. Polymers suitable for this purpose are styrene-butadiene block copolymers and olefin copolymers, and terpolymers, preferably polyethylene and polypropylene, which, if appropriate, have been modified via addition of from 0 to 40% by weight of a styrene-butadiene block copolymer, particularly preferably polyethylene and polypropylene with addition of from 0.1 to 30% by weight of a styrene-butadiene block copolymer.

The internal layer can be identical with or different from the shell. It is preferable that the same materials are used for the shell and the internal layer.

The middle layer forms a vapor barrier inhibiting discharge of vaporizable or gaseous contents of the hollow body, e.g. water, alcohols, odorants, flavors, gases, e.g. air, carbon dioxide, nitrogen, or oxygen, or mixtures of these substances. The barrier action can encompass individual components from this list or a plurality of components; by way of example, therefore, it is possible that there is an elevated water-vapor barrier but no improved barrier in respect of oxygen and/or carbon dioxide. It is preferable that the middle layer forms a barrier to water, odorants, or flavors. It is particularly preferable that the barrier layer acts as water-vapor barrier. Various methods can be used to determine the barrier action, an example being concentration decrease or weight loss on storage, in accordance with DIN 53380, DIN 53536, DIN 52429, or ASTM F-1249.

The hollow bodies of the invention with improved barrier action can be produced as follows:

The hollow bodies can be produced using the blow molds described in C. A. Harper, Handbook of Plastic Processes, Hoboken/N.J.: Wiley, 2006, or M. Thielen, Blasformen von Kunststoff-Hohlkörpern [Blow molding of hollow plastics bodies], Munich: Hanser, 2006. Various methods can be used to obtain these hollow bodies, examples being injection blow molding, extrusion blow molding, or injection stretch blow molding. It is particularly preferable that injection stretch blow molding is used to produce the hollow bodies. In a possible method for this, 1.) a preform is produced by the method of multi-component injection molding. Here, pellets made of polystyrene and pellets made of polyolefin can be melted and injection-molded to give a preform. The injection-molding process can be carried out in such a way that the preform itself exhibits a structure made of three layers. The resultant preform can then 2.) be transferred to a second mold, where it is stretched and blown.

Multicomponent injection molding is the sequential combination of a plurality of melts in a mold during the injection-molding process. These melts can be conducted onto one another or into one another. The resultant composites can be inseparable, or else can be capable of mutual movement. The process is described by way of example in: Mehrkomponentenspritzgieβtechnik 2000 [Multicomponent injection-molding technology 2000], Springer VDI Verlag, ISBN 3-935065-00-0.

The injection-molding process usually uses the parameters recommended by the manufacturers. By way of example, the pellets are usually injection-molded at temperatures of from 200 to 280° C. The polystyrene component is generally injected at below 260° C., preferably below 250° C. It is also possible that the melt is processed with substantial exclusion of oxygen in the injection-molding process, for example by covering the pellets with a current of nitrogen in the feed region of the injection-molding machine.

The injection-molding process can itself provide preformed design features, in particular for the regions which subsequently are subjected to no, or little, stretching. In particular, the result can be shaping of features that are important for the closure, examples being screw threads, snap connectors, cap strips, etc.

Various embodiments of the injection stretch blow molding process that are known in principle can be used to obtain the preforms.

The preforms are usually heated above the softening point of the polystyrene matrix, in a first step. It is preferable to heat the preforms above 110° C., particularly above 115° C. It is preferable that the preforms are not heated above 190° C., and it is particularly preferable that they are not heated above 160° C., and it is very particularly preferable that they are not heated above 150° C. Various methods can be used for the heating process, examples being use of warm air, or use of IR or NIR radiation.

The preforms are then preblown, by using a low preliminary pressure. Typical preliminary pressures are in the range from 0.5 to 15 bar, preferably 1 to 15 bar, very particularly preferably in the range from 2 to 10 bar.

During or after the preblowing step, a prestretcher ram is moved into the preform, the length of which is thus subjected to prestretching. The prestretching speed is usually from 0.1 to 3 m/s, preferably from 0.2 to 2 m/s, particularly preferably from 0.7 to 1.8 m/s, but can also be higher or, if appropriate, lower. The extent to which the prestretcher stretches the hollow body is from 10 to 100% of its final length, preferably from 20 to 100%, very particularly preferably from 40 to 100%.

In another possible prestretching method, stretching tongs grip the body externally and stretch it longitudinally.

Prior to, during, or after the prestretching process, the hollow body is subjected to blowing pressure.

A blowing pressure of not more than 25 bar, preferably not more than 20 bar, and very particularly preferably not more than 15 bar, has proven to be advantageous for the production of bottles, as also has a minimum blowing pressure which is not less than 1 bar, preferably not less than 2 bar, particularly preferably not less than 4 bar.

The control of the process is preferably such that the polymer of the barrier layer and the polymer of the polystyrene layer can be subjected to similar levels of stretching. This can be achieved via selection of the process conditions and/or selection of the polymers.

During the blowing process, the bottles are usually pressed against a mold which impresses various design features onto the bottle, in particular features which improve the mechanical stability of the bottle, which give information about the material and about the manufacture, or which are important for the handling of the bottle, or which have aesthetic purposes.

There may also be a plurality of passes through individual stages of the process, and by way of example the heating process and optionally the preblowing process and/or the prestretching process can initially take place only in one subregion (e.g. the subsequent neck section or base section). If appropriate, the entire preform or the remaining subregion is then heated in a second step, and is shaped via a stretch blowing process to give its final shape. The product can then be blown at from 110 to 190° C., preferably from 115 to 150° C.

To the extent that the bottles/cups are used for food or drink, a sterilization step is often advisable. An example of a method for this is washing with aqueous hydrogen peroxide solution and subsequent drying.

The bottles can be given further design features by known processes, for example printed, cartonized, or provided with a shrink sleeve. In one embodiment of the invention, the container is provided with a shrink sleeve which comprises at least one styrene-butadiene copolymer. Shrink sleeves of this type have been described by way of example in WO-A-06/074819, or in WO-A-2009/156 378. It is therefore possible to recycle the bottle together with the shrink sleeve with no need for expensive separation of the sleeve and separate recycling of the components. Particular preference is given here to bottles where the polyolefin components have been equipped with an addition made of a styrene-butadiene block copolymer.

The bottles can be sealed by various known methods, for example by using snap closures or screw closures. It is preferable to use screw-cap closures, preferably made of polyolefins or of polystyrenes.

The hollow bodies of the invention with improved barrier action are suitable for filling with liquids, such as solutions, suspensions, emulsions, or dispersions, or with flowable solids, and preferably for filling with dairy products, soft drinks, cosmetic compositions, detergents, and cleaners, animal feed, cereals, drinks powders, instant foods and drinks, or with edible oils, or with acids or bases, or with fuel additives, and are particularly preferably suitable for filling with dairy products, examples being whey drinks, buttermilk drinks, milk, and milk drinks.

### EXAMPLES

Materials Used:
HIPS: impact-resistant polystyrene with average molecular weight 193 000 D, 7.9% polybutadiene content, flowability 4.6 ml/10 min, modulus of elasticity 1880 MPa, and yield stress 25.6 MPa.
PP: Stretchene® PR 1685 polypropylene from Basell with MFR 230/2.16=10 g/10 min, density=0.9 g/cm³
LDPE: Lupolen® 2420 H low-density polyethylene from Basell with MFR 190/2.16=1.9 g/10 min, density<0.935 g/cm³
HDPE: Hostalen® GD 4755 high-density polyethylene from Basell with MFR 190/2.16=1.9 g/10 min, density>0.940 g/cm³
Styroflex: a thermoplastic elastomer based on styrene and butadiene, BASF SE, Styroflex® 2 G 66, MVR 200/5=13 cm³/10 min

The following preforms (20 g) were injection molded:
A. Preform made of HIPS (reference)
B. Three-layer preform with internal layer made of 1.51 9 PP
C. Three-layer preform with internal layer made of 0.75 g of PP
D. Three-layer preform with internal layer made of LDPE
E. Three-layer preform with internal layer made of HDPE
F. Three-layer preform with internal layer made with a mixture of 80% of PP and 20% of Styroflex
G. Three-layer preform with internal layer made with a mixture of 80% of LDPE and 20% of Styroflex
H. Three-layer preform with internal layer made with a mixture of 80% of HDPE and 20% of Styroflex
K. Two-layer preform made of HIPS external layer and internal layer made of PP
L. Two-layer preform made of HIPS external layer and internal layer made of PE-HO
M. Three-layer preform with internal layer made of a mixture of 80% of PP and 20% of Styroflex and with an external and internal layer made of a mixture of HIPS and 20% of Styroflex

The styrene polymers were injection molded at a melt temperature of 240° C., and the polyolefins were injection molded at a melt temperature of 260° C. The injection pressures were 460 bar for the styrene polymers and 370 bar for the polyolefins.

Bottle Production:

The preforms were heated in a production line above the softening in point (about 125° C.), and processed at a preliminary pressure of from 6 to 8 bar, a blowing pressure of 14 bar, and a stretching-bar speed of 1300 mm/s, to give bottles of capacity 1 liter and 38 mm mouth aperture. In comparison with the reference (preform exclusively made of HIPS), the heating time was lengthened by 8 sec. for the preforms with polyolefin barrier layer.

Topload Determination

The bottles were filled with 1 liter of water. The maximum vertical load that can be applied to the bottle from above without rendering the bottle unstable was then determined.

### INVENTIVE EXAMPLES 1 TO 6

| Inventive | | Preheat temperature, | Topload |
|---|---|---|---|
| example | Preform | preliminary pressure | [kg] |
| 1 | C | 126° C., 8 bar | 22 |
| 2 | D | 130° C., 8 bar | 23.7 |
| 3 | E | 124° C., 6 bar | 25.6 |
| 4 | F | 126° C., 6 bar | 25.3 |
| 5 | G | 128° C., 8 bar | 21 |
| 6 | H | 127° C., 8 bar | 23.5 |

All of the bottles of inventive examples 1 to 6 had good shaping. After filling with water, all of the bottles were stable under high topload, with no mechanical failure. All of the bottles also withstood a gauge pressure of 2 bar without bursting.

Unfilled bottles of inventive examples 1 to 6 were subjected to increased mechanical load. For this, the bottles were subjected to vigorous flexing between the hands. Intensive flexing of bottles of inventive examples 1 to 3 caused some delamination of the polymeric layers. This was discernible from a crackling sound during flexing. This did not occur with the bottles of inventive examples 4 to 6, even on prolonged flexing.

### Comparative Example 1

(According to WO-A-2008/40 821, Example No.: 3)

Preform A was heated to 123° C. and processed without difficulty to give good bottles, using a preliminary pressure of 8 bar. After filling with water, all of the bottles were stable under a topload of more than 20 kg. All of the bottles withstood a gauge pressure of 2 bar, without bursting.

### Comparative Example 2

(By Analogy with WO-A-2008/40 821, Example No.: 5, but Without Three-layer Structure)

Preform K was heated to various temperatures in the range from 120 to 150° C., and processed with various settings of preliminary pressure and blowing pressure and various ram speeds. It was not possible to obtain a usable bottle under any conditions.

### Comparative Example 3

(By Analogy with WO-A-2008/40 821, Example No.: 5, but Without Three-layer Structure)

Preform L was heated to various temperatures in the range from 115 to 140° C., and processed with various settings of preliminary pressure and blowing pressure and various ram speeds. It was not possible to obtain a usable bottle under any conditions. The inner layer repeatedly separated from the outer layer, or the unstretched polyethylene core protruded within the bottle. When the blowing temperature was raised, there was increasing occurrence of preform break-off during the stretching process.

When inventive examples 1 to 6 are compared with comparative examples 2 and 3, it is apparent that bottles of quality similar to that of comparative example 1 can be produced if the preform has a three-layer structure with a specific middle layer.

The results for water-vapor permeability of the bottles with and without middle barrier layer were determined and are shown in the table below. For this, the bottles were filled with 1 liter of water and sealed with a screw cap made of polyethylene and weighed, and stored vertically at room temperature and about 60% rel. humidity. The bottles were reweighed after 89 days and the difference in weight was determined:

| Bottle made of | Weight loss [g] | % |
|---|---|---|
| Comparative example 1 | 18.7 | 2.7 |
| Preform F | 5.2 | 0.7 |
| Preform G | 8.0 | 1.1 |
| Preform H | 5.7 | 0.8 |
| Preform M | 4.9 | 0.7 |

The numbers provide evidence of the marked improvement in the barrier properties of the bottles by virtue of the middle barrier layer.

1.-6. (canceled)

7. A hollow body with improved barrier action, wherein the hollow body is composed of a three-layer sandwich structure with a shell made of polystyrene and with a middle layer as vapor barrier.

8. The body according to claim 7, wherein the middle layer is a polyolefin.

9. The body according to claim 8, wherein the middle layer also comprises from 0.1 to 30% of a styrene-butadiene block copolymer.

10. A process for producing a hollow body according to claim 7, which comprises first producing a hollow body made of polystyrene and of a middle layer as vapor barrier, in an injection-molding process, and then using blow molding to shape said body.

11. The process according to claim 10, wherein injection stretch blow molding is used to shape the body.

12. The process according to claim 10, wherein the middle layer is a polyolefin.

13. The process according to claim 10, wherein the middle layer also comprises from 0.1 to 30% of a styrene-butadiene block copolymer.

14. A bottle which comprises the hollow body according to claim 7.
